(19) United States
(12) Patent Application Publication
(10) Pub. No.: US 2012/0279605 A1
(43) Pub. Date: Nov. 8, 2012

(54) POLYAMIDE COMPOSITIONS FOR THE INNER LAYER OF A MULTI-LAYER TUBULAR ARTICLE AND ARTICLES INCORPORATING SAME

(75) Inventors: Masahiro Nozaki, Tochi (JP); Shailesh Ratilal Doshi, Kingston (CA)

(73) Assignee: E.I. Du Pont De Nemours And Company, Wilmington, DE (US)

(21) Appl. No.: 13/463,067

(22) Filed: May 3, 2012

Related U.S. Application Data
(60) Provisional application No. 61/482,318, filed on May 4, 2011.

(51) Int. Cl. C08L 77/02; F16L 11/00; C08K 5/13

(52) U.S. Cl. 138/137; 524/323

(57) ABSTRACT

Polyamide compositions suitable for the inner layer of multi-layer tubular articles for circulating a heat transfer fluid composition within a refrigeration or air conditioning system are provided and including articles prepared from these compositions. Such compositions are particularly suitable in air conditioning and refrigeration applications and systems in which new, low global warming potential refrigerant alternatives are used.

### CROSS REFERENCE TO RELATED APPLICATIONS

This application claims priority to Application No. 61/482,318, filed May 4, 2011

### FIELD OF THE INVENTION

The present invention relates to polyamide compositions suitable for the inner layer of a multi-layer tubular article for circulating a heat transfer fluid composition within a refrigeration or air conditioning system and to articles prepared from these compositions. More particularly, the present invention relates to constructing hoses in multi layers of which the inner layer is exposed to a heat transfer fluid composition circulated within said system, made from these compositions.

### BACKGROUND OF THE INVENTION

As is widely understood by those having skill in the field, in a typical refrigeration or air conditioning system heat transfer fluids are circulated within a closed loop including a compressor, a condenser and an evaporator. Hoses are typically connected between the outlet of the compressor and the inlet of the condenser; between the outlet of the condenser and the inlet of the evaporator; and between the outlet of the evaporator and the inlet of the compressor. Such hoses must be able to withstand the higher pressure of the fluids which are circulated through such system.

Hoses used for these purposes need to be flexible for ease of installation and use, and often must be shaped into curves and bends for connecting components already installed into fixed positions. They must also be able to contain the fluid pressure. These hoses are often made of elastomeric materials such as natural or synthetic rubber or thermoplastic elastomers, and are typically reinforced with braiding to impart high pressure capability.

Moreover, it is essential that the hoses of such systems offer superior barrier resistance to permeation of the contained fluid through the wall of the hose construction. In addition, the hose wall must provide high barrier resistance to the ingression of external fluids, such as air or moisture, into the contained fluid.4

In order to meet barrier requirements, hoses are often provided with a suitable thermoplastic barrier layer on the inside. A typical high pressure barrier hose may thus consist of multiple layers—an inner thermoplastic barrier layer made of a polyamide, an over-layer of an elastomeric material to provide flexibility; and a braid layer over the elastomeric layer to provide pressure capability and an outer protective cover layer of an elastomeric material. Further environmental regulations may ultimately cause global phase out of certain HFC refrigerants. Currently, the automobile industry is facing regulations relating to global warming potential (GWP) for refrigerants used in mobile air-conditioning. Therefore, there is a great current need to identify new refrigerants with reduced global warming potential for the automobile air-conditioning market. Should the regulations be more broadly applied in the future, an even greater need will be felt for refrigerants that can be used in all areas of the refrigeration and air-conditioning industry. The inner barrier layer has commonly used polyamide 6 based resin containing elastomeric material and copper compounds as a nylon heat stabilizer to obtain higher refrigerant barrier, flexural properties and long term durability of the layer.

However because of development of low GWP refrigerants, conventional polyamide layer materials do not sustain over the expected whole automotive life due to crack generation on the surface by degradation of the nylon polymer. A need exists for polyamides which are suitable for use with new, low GWP refrigerants without cracking and degradation even when exposed to low GWP.

The introduction of hindered-phenol type anti-oxidants into the conventional polyamide inner layer material surprisingly improves the durability of the polyamide inner layer.

### BRIEF DESCRIPTION OF THE DRAWING

FIG. 1 a perspective view in partial cross-section of one of the multi-layer tubular articles of the invention for circulating a heat transfer fluid composition within a refrigeration or air conditioning system

### SUMMARY OF THE INVENTION

There is disclosed and claimed herein a polyamide composition for an inner layer of a multi-layer tubular article useful for circulating a heat transfer fluid composition within a refrigeration or air conditioning system, comprising a) 50 to 90 weight percent of one or more polyamides; b) 10 to 50 weight percent of toughener polymerized from alpha olefin monomers, diene monomers, or mixtures thereof; c) 0.05 to 8 weight percent of one or more hindered phenol antioxidants; d) 0 to 15 weight percent of plastizer, said weight percentages based on total weight of composition, and e) a copper-based heat stabilizer with a content of copper in the range of 40 to 1500 ppm, wherein said heat transfer fluid composition comprises a compound selected from the group consisting of R32, R152a, Cf3I, 1234yf, 1225ye and trans-1234ze.

Weight percentages are based on the total weight of the composition. Moreover component (b) in a preferred embodiment may be selected from the group consisting of rubber polyethylene, and ionomeric copolymer.

### DETAILED DESCRIPTION OF THE INVENTION

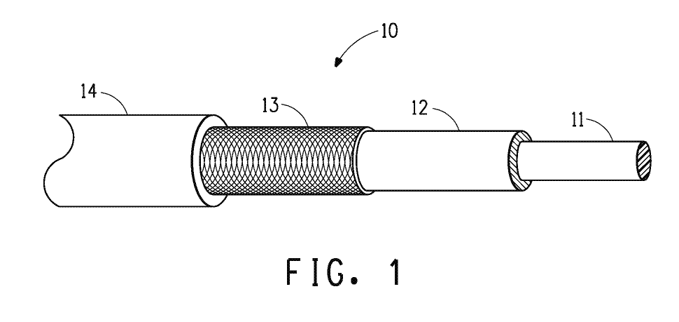

Having reference to FIG. 1, there is shown a perspective cut-away view of a hose for circulating a heat transfer fluid composition within a refrigeration or air conditioning system. A typical high pressure barrier hose 10 is comprised of an inner thermoplastic barrier layer 11 surrounded by an over-layer 12 of elastomeric material to provide flexible, that is surrounded by a braid layer 13 to provide pressure capability, that is in turn surrounded by an outer protective cover layer 14.

An aspect of the present invention provides a polyamide composition for an inner layer of a multi-layer tubular article useful for circulating a heat transfer fluid composition within a refrigeration or air conditioning systems which is suitable for use with HFC refrigerants, having a global warming potential of less than 1000.

A further aspect of the present invention relates to a hose for circulating a heat transfer fluid composition within the refrigeration or air conditioning system, which comprises a) an inner thermoplastic barrier layer; b) an over-layer which is positioned over the inner thermoplastic barrier layer; c) a braid layer that is positioned over the over-layer; and d) an outer layer that is positioned over the braid layer.

Further this hose would not require the use of aggressive chemicals such as bonding techniques which was conventionally used to fabricate high pressure barrier hoses using a metallic tube, would be economical to make, and would meet stringent barrier requirements. The HFC refrigerants are available commercially or may be prepared by processes know in the art as described in U.S. Pat. No. 7,914,698, incorporated by reference.

So long as they do not affect the advantageous performances of the ingredients (a)-(d) above, other ingredients may be present in the compositions of the invention. The other ingredients include but are not limited to, lubricants, plasticizer, anti oxidants, UV stabilizers, impact modifiers, inorganic filler, and fiberform reinforcement agent other than glass fiber.

The compositions of the present invention are melt-mixed blends. Any melt-blending method may be used to prepare the compositions. For example, the polymeric components and non-polymeric ingredients may be added to a melt mixer, such as, for example, a single or twin-screw extruder; a blender; a kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and then with the non-polymeric ingredients being subsequently added and further melt-mixed until a well-mixed composition is obtained.

Polyamides used in the composition of the present invention are well known to those skilled in the art. Polyamide can be semicrystalline polyamide, which is well known to one skilled in the art such as those produced from lactams or amino acids or from condensation of diamines such as hexamethylene diamine with dibasic acids such as sebacic acid. Copolymers and terpolymers of these polyamides are also included. Examples include, but are not limited to, polyepsiloncarprolactam (nylon-6), polyhexamethylene adipamide (nylon-66), nylon-11, nylon-12, nylon-12,12, nylon-6166, nylon-61610, nylon-6/12, nylon-66/12, nylon-6/66/610, nylon-6/6T, and combinations of two or more thereof. Frequently used polyamides are nylon 6.

The composition of the present invention incorporates from 15 wt % percent to 50 wt % of toughener, more preferably from 20 wt % to 40 wt %, based on the total weight of the composition. If the amount of toughener is within this range, the composition can be easily processed as a film into a variety of article with an acceptable level of toughness. As toughener (also referred to as impact modifier), in general, elastomers can be used. Useful elastomers include an elastomer consisting of ethylene-α-olefin, an elastomer consisting of ethylene-propylene-diene. an elastomer consisting of ethylene-unsaturated carboxylic acid, an elastomer consisting of ethylene-unsaturated carboxylic acid ester, an elastomer consisting of ethylene-unsaturated carboxylic acid-unsaturated carboxylic acid ester, an elastomer consisting of α-olefin-unsaturated carboxylic acid, an elastomer consisting of cc-olefin-unsaturated carboxylic acid ester, an elastomer consisting of α-olefin-unsaturated carboxylic acid-unsaturated carboxylic acid ester, an elastomer consisting of α-olefin-unsaturated carboxylic acid-unsaturated carboxylic acid ester; and graft modified materials of he above-mentioned elastomers. Two or more of unmodified elastomers or modified elastomers may also be blended. At least one of the above-mentioned unmodified elastomers and at least one of the above-mentioned modified elastomers may also be blended. Preferably, an elastomer consisting essentially of ethylene-propylene-diene modified with carboxylic acid-carboxylic acid anhydride can be used. The elastomer consisting essentially of ethylene-propylene-dienes modified with carboxylic acid-carboxylic acid anhydride, may be, for example, a mixture of ethylene/propylene/1,4-hexadiene-g-maleic anhydride/ethylene/propylene/1,4-hexadiene and ethylene/maleic anhydride; a mixture of ethylene/propylene/1,4-hexadiene and is ethylene/propylene/1,4-hexadiene-g-maleic anhydride; ethylene/propylene/1,4-hexadiene/norbornadiene-g-maleic anhydride fumaric acid; ethylene/1,4-hexadiene/norbornadiene-g-maleic anhydride monoethyl ester; ethylene/propylene/1,4-hexadiene/norbornadiene-g-fumaric acid; a mixture of ethylene/propylene/1,4-hexadiene and ethylene/monoethyl ester of maleic anhydride; a mixture of ethylene/propylene/1,4-hexadiene and ethylene/maleic acid monobutyl ester; a mixture of ethylene/propylene/1,4-hexadiene and ethylene/maleic anhydride, etc. Furthermore, polyethylene, polypropylene and other polyolefins and their copolymers, and styrine-type elastomers can also be appropriately used as impact modifiers.

The polyamide composition of this invention may contain up to 15 weight percent (and preferably about 6 weight percent) of plastizer, based on total weight of the composition.

The polyamide composition of this invention contains an essential copper based thermal stabilizer. The copper based thermal stabilizer will preferably be present in the range of from 15 wt % to 50 wt %, based on the total weight of the composition. Examples of such thermal stabilizers are those containing copper in which the copper content is preferably 40 to 1500 ppm, more preferably 70 to 800 ppm. If the content of copper is not greater than 40 ppm, the durability of the formed film can be lower, resulting into raising crack problem. If the content of copper is greater than 1500 ppm, the formed film can be brittle, resulting into not being of acceptable durability.

The polyamide composition of this invention comprises copper-based heat stabilizer (e.g., in a form of copper salt or copper salt derivatives such as for example copper iodide, copper bromide or copper halides or derivatives thereof, or mixtures thereof). Copper(I) salts are preferred. Examples of the heat stabilizer include without limitation copper iodide, copper bromide, copper chloride, copper fluoride; copper thiocyanate, copper nitrate, copper acetate, copper naphthenate, copper caprate, copper laurate, copper stearate, copper acetylacetonate; copper oxide. Preferably, the heat stabilizer is copper halide being selected from the group consisting of copper iodide, copper bromide, copper chloride, and copper fluoride, and still preferably, is copper iodide, and more preferably copper (I) iodide.

A copper halide such as copper iodide such as CuI-KI stabilizer or copper bromide is particularly desirable. An alkyl halogen compound is ordinarily added as an auxiliary thermal stabilizer.

In another embodiment the polyamide composition of this invention may further comprise 0.004 to 5.0 weight % of an metal halide salt in combination with LiI, NaI, KI, MgI₂, KBr, or CaI₂ as the heat stabilizer, the weight percent being based on the total weight of the polyamide composition. When present, to the metal halide is preferably KI or KBr.

In order to provide such level of copper content in the polyamide composition of the invention, the stabilizer is present in the range of from about 0.1 weight % to about 4%.

Hindered phenol anti oxidants (also referred to as hindered phenol stabilizer) comprised in the polyamide composition of this invention, to hinder thermally induced oxidation of polyamide where high temperature applications are used, are chemical compounds containing the following functionality groups in the chemical structure.

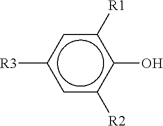

R1 and R3 are composed of hydrocarbon group, such as methyl, ethyl, propyl, butyl, t-nutyl and others. R3 is either hydrogen or other organic compounds. Examples materials are di-butyl hydroxyl benzene (BHT), Irganox® 1010, Irganox® 1098, Irganox®245 (commercially available from Chiba under the trademark Irganox®), Adekastab AO-80 (commercially available from Asahi Denka Kogyo) or other hindered phenol antioxidants.

The hindered phenol stabilizer content is preferably in an amount from 0.05 weight % to 8 weight % and preferably from 0.1 to 5 weight percent, the weight percent being based on the total weight of the polyamide composition. If the content of the hindered phenol stabilizer is not greater than 0.05 weight %, the durability of the formed film can be insufficient because of loss of Mw. If the content of the hindered phenol stabilizer is greater than 8 weight % it is difficult to produce a compounded resin due to sever surging and strand breakage.

Any conventional method can be used for making the hoses of the invention including the inner thermoplastic barrier layer, the over-layer of elastomeric materials and the braid layer. For instance, one common technique involves disposing the inner thermoplastic barrier layer, the over-layer of elastomeric materials and the braid layer on a mandrel in this order and curing and adhering these layers by press vulcanization, steam vulcanization, oven vulcanization (hot air vulcanization) or hot water vulcanization under the condition of 130 to 180 degree C. and 30 to 120 minutes.

It is readily apparent to those having skill in the art to which this invention pertains that in addition to the materials mentioned herein, a variety of other materials are suitable for each layer as is well known and understood. Likewise, representative thicknesses of each layer and techniques for braiding are already well appreciated by those having skill in the field, and are selected according to the intended application.

In accordance with the method of the present invention, the heat transfer fluid composition comprises a compound selected from the group consisting of: R32, R152a, CF₃I, 1234yf, 1225ye and trans-1234ze.

### EXAMPLES

The invention will become better understood upon having reference to the Examples herein. These examples and the comparative example to the invention are given below by way of illustration, and not by way of limitation.

### Example 1 to 3 and Comparative Example 1

The components shown in Table 1 were blended at a ratio (parts by weight) shown in Table 1 to prepare polyamide compositions for the inner layer of a multi-layer tubular article suitable for circulating a heat transfer fluid composition within a refrigeration or air conditioning system.

Each composition was inject-molded into 5 mm (w)×50 mm (h)×1 mm (t) test bars. The molded test bars were put in the glass tube with approximately 10 mm diameter and 100 mm height capable to be pulled vacuum and heat sealed.

### Measurement of Weight Average Molecular Weight (Mw)

The weigh average molecular weight (Mw) was determined by gel permeation chromatography (GPC) method using the following apparatus and the conditions specified below.

Measure Mw of Polyamide 6 by GPC (Shodex, manufactured by Showa Denko Co.) dissolved in HFIP (hexafluoroisopropyl alcohol) (0.1% polyamide solution) with Shodex GPC HFIP 606Mx2 column (as isolation column) for analysis.

The shield aging test was made to measure the retention of Mw of the composition of the present invention before and after being subjected to the test. The results are shown in Tables 1 and 2.

### a) Shield Aging Test

Test bars: Injection molded test bar with 5 mm (w)×50 mm (h)×1 mm (t)

Put the bar in the glass tube with approxi. 10 mm diameter and 100 mm hight. capable to be pulled vacuum and heat sealed.

Load 3.5 grams oil (Apollo PS-46 PAG oil) in each tube.

Load 1.75 g refrigerant (1234yf) after the tube is pulled vacuum.

Further load 760 mm Hg air in the tube, and then sealed the tube.

Aged at 150C×6 days in an oven

In addition, the properties of the polyamide compositions of the present invention corresponding to basic requirements from constructing hoses described herein are measured by the following procedures.
b) Melt viscosity measured on Kayness viscometer at 280C and 1000 sec-1 shear rate after 5 min. hold-up at 280C.
c) Notched charpy impact strength measured based on ISO 179.
d) Elongation and elongation after air oven aging (AOA). Elongation is measured based on ISO 527. The bars are aged in a dry over at 150° C. for 500 hours and the elongation is subsequently measured.
All properties' are summarized on the Tables 1 and 2.

TABLE 1

| | Exp. 1 | Exp. 2 | Exp. 3 | Comp. 1 |
|---|---|---|---|---|
| PA6 (RV 90) | 70.7 | 70.7 | 70.7 | 71.7 |
| MHA-EPDM rubber | 28 | 28 | 28 | 28 |
| Cu heat stabilizer | 0.3 | 0.3 | 0.3 | 0.3 |
| Cu in the stabilizer (ppm) | 120 | 120 | 120 | 120 |
| AO-80 | 1.0 | | | |
| Irganox 245 | | 1.0 | | |
| Irganox 1010 | | | 1.0 | |
| PA6 Mw Initial | 72000 | 74000 | 72000 | 74000 |
| PA6 Mw after shield aging test | 19000 | 16000 | 19000 | 12000 |
| % retention of Mw | 26 | 22 | 26 | 16 |
| Melt viscosity (Pa · sec) | 210 | 200 | 210 | 230 |
| N-Charpy impact strength | 88 | 87 | 85 | 86 |
| (kJ/m2) | | | | |
| Elongation (%) | >200 | >200 | >200 | >200 |
| Elongation after air oven aging | 32 | 30 | 32 | 35 |
| (%) | | | | |

TABLE 2

| | Exp. 4 | Exp. 5 | Exp. 6 | Exp. 7 |
|---|---|---|---|---|
| PA6 (RV 90) | 83.7 | 78.7 | 58.7 | 48.7 |
| MHA-EPDM rubber (%) | 15 | 20 | 40 | 50 |
| Cu heat stabilizer (%) | 0.3 | 0.3 | 0.3 | 0.3 |
| Cu in the stabilizer (ppm) | 120 | 120 | 120 | 120 |
| AO-80 (%) | 1 | 1 | 1 | 1 |
| PA6 Mw Initial | 73000 | 74000 | 72000 | 74000 |
| PA6 Mw after shield aging test | 19000 | 22000 | 25000 | 22000 |
| Retention oif Mw (%) | 26 | 30 | 35 | 30 |
| Melt viscosity (Pa · sec) | 206 | 221 | 268 | 302 |
| N-Charpy impact strength | 70 | 71 | 109 | 68 |
| (kJ/m2) | | | | |
| Elongation (%) | >200 | >200 | >200 | >200 |
| Elongation after air oven aging | 29 | 27 | 62 | 27 |
| (%) | | | | |

| | Comp. 2 | Comp. 3 | Exp. 8 | Exp. 9 |
|---|---|---|---|---|
| PA6 (RV 90) | 88.7 | 43.7 | 70.9 | 70.83 |
| MHA-EPDM rubber (%) | 10 | 55 | 28 | 28 |
| Cu heat stabilizer (%) | 0.3 | 0.3 | 0.1 | 0.17 |
| Cu in the stabilizer (ppm) | 120 | 120 | 39 | 67 |
| AO-80 (%) | 1 | 1 | 1 | 1 |
| PA6 Mw Initial | 72000 | | 73000 | 73000 |
| PA6 Mw after shield aging test | 18000 | | 23000 | 22000 |
| Retention oif Mw (%) | 25 | | 32 | 30 |
| Melt viscosity (Pa · sec) | 130 | | 202 | 257 |
| N-Charpy impact strength | 28 | | 87 | 82 |
| (kJ/m2) | | | | |
| Elongation (%) | >200 | | >200 | >200 |
| Elongation after air oven aging | 26 | | 25 | 30 |
| (%) | | | | |

| | Exp. 10 | Exp. 11 | Comp. 4 | Comp. 5 |
|---|---|---|---|---|
| PA6 (RV 90) | 69 | 68.3 | 70.95 | 66 |
| MHA-EPDM rubber (%) | 28 | 28 | 28 | 28 |
| Cu heat stabilizer (%) | 2 | 2.7 | 0.05 | 5 |
| Cu in the stabilizer (ppm) | 800 | 1100 | 20 | 1960 |
| AO-80 (%) | 1 | 1 | 1 | 1 |
| PA6 Mw Initial | 72000 | 74000 | 74000 | 73000 |
| PA6 Mw after shield aging test | 22000 | 21000 | 20000 | 16000 |
| Retention oif Mw (%) | 31 | 28 | 27 | 22 |
| Melt viscosity (Pa · sec) | 231 | 227 | 206 | 160 |
| N-Charpy impact strength | 90 | 92 | 87 | 79 |
| (kJ/m2) | | | | |
| Elongation (%) | >200 | >200 | >200 | >200 |
| Elongation after air oven aging | 43 | 33 | 14 | 19 |
| (%) | | | | |

| | Exp. 12 | Exp. 13 | Exp. 14 | Exp. 15 | Comp. 6 |
|---|---|---|---|---|---|
| PA6 (RV 90) | 71.65 | 71.6 | 66.7 | 64.7 | 62.7 |
| MHA-EPDM rubber (%) | 28 | 28 | 28 | 28 | 28 |
| Cu heat stabilizer (%) | 0.3 | 0.3 | 0.3 | 0.3 | 0.3 |
| Cu in the stabilizer (ppm) | 120 | 120 | 120 | 120 | 120 |
| AO-80 (%) | 0.05 | 0.1 | 5 | 7 | 9 |
| PA6 Mw Initial | 72000 | 74000 | 72000 | 74000 | |
| PA6 Mw after shield aging test | 19000 | 20000 | 20000 | 23000 | |
| Retention oif Mw (%) | 26 | 27 | 28 | 31 | |
| Melt viscosity (Pa · sec) | 225 | 216 | 200 | 200 | |
| N-Charpy impact strength | 87 | 85 | 75 | 88 | |
| (kJ/m2) | | | | | |
| Elongation (%) | >200 | >200 | >200 | >200 | |
| Elongation after air oven aging | 49 | 38 | 29 | 31 | |
| (%) | | | | | |

The various components of
Tables 1 and 2 are as follows:

### Ingredients

PA6 (RV90) Unextracted Polyamide 6 with RV 90 measured in folmic acid (ASTM D789)

MHA-EPDM rubber: maric anhydride modified EPDM

Cu stabilizer: Mixture of CuI/KI

AO-80: Hindered phenolic antioxidant supplied by

### ADEKA

Irganox 245: Hindered phenol antioxidant supplied by BASF

Irganox 1010: Hindered phenol antioxidant supplied by BASF

As shown in Tables 1 and 2, the samples comprising toughener and copper based heat stabilizer within the ranges meet with the requirements from constructing hoses for the applications, i.e. melt viscosity, n-charpy impact strength, and retention of elongation after air oven aging, respectively, as compared with the comparative examples.

What is claimed is:

1. A polyamide composition for an inner thermoplastic barrier layer of a multi-layer tubular article for circulating a heat transfer fluid composition within a refrigeration or air conditioning system comprising, a) 30 to 90 weight percent of one or more polyamides; b) 10 to 50 weight percent of toughener polymerized from alpha olefin monomers, diene monomers, or mixtures thereof; c) 0.05 to 8 weight percent of one or more hindered phenol antioxidants; d) 0 to 15 weight to percent of plastizer, said weight percentages based on total weight of composition; and e) a copper-based heat stabilizer with a content of copper in the range of 40 to 1500 ppm, wherein said heat transfer fluid composition comprises a compound selected from the group consisting of: R32, R152a, Cf3I, 1234yf, 1225ye and trans-1234ze.

2. The polyamide composition to claim 1, where the polyamide is polyepsiloncarprolactam (nylon 6)

3. A hose for circulating a heat transfer fluid composition within a refrigeration or air conditioning system, comprising a) an inner thermoplastic barrier layer; b) an over-layer which is positioned over the inner thermoplastic barrier layer; c) a braid layer that is positioned over the over-layer; d) an outer layer that is positioned over the braid layer, wherein the inner thermoplastic barrier layer is formed from the composition of claim 1 or 2, and said heat transfer fluid composition comprises a compound selected from the group consisting of: R32, R152a, Cf3I, 1234yf, 1225ye and trans-1234ze.
